(19) United States
(12) Patent Application Publication
(10) Pub. No.: US 2025/0105572 A1
(43) Pub. Date: Mar. 27, 2025

(54) SELF-SUPPORTING MODULAR STACKABLE SLIPRING MODULE

(71) Applicant: Schleifring GmbH, Fürstenfeldbruck (DE)

(72) Inventors: Michael Kiser, Kottgeisering (DE); Arthur Maier, Germering (DE)

(21) Appl. No.: 18/749,489

(22) Filed: Jun. 20, 2024

(30) Foreign Application Priority Data
Jun. 27, 2023 (EP) 23181803.1

(51) Int. Cl. H01R 39/64

(52) U.S. Cl. CPC H01R 39/64

(57) ABSTRACT

A support block configured to form a self-supporting modular slipring module that includes an electrically insulating material and is configured to hold at least one sliding track. The support block includes a generally disk-shaped body having a center opening or bore at a center axis and connecting means, at the body, that are configured to form a fixed connection with at least another similarly structured support block. In one specific non-limiting case, the connecting means includes 6 protrusions with 3 protrusions of a first type and 3 protrusions of a second type, alternatingly arranged. Protrusion of the first type have extending protrusion at their ends, protrusions of the second type have recesses at their ends, and the extending protrusions are dimensioned to fit into the recesses by a press fit.

### CROSS-REFERENCE TO RELATED APPLICATIONS

This US Patent Application claims priority to and benefit of the pending European Patent Application No. 23181803.0 filed on 27 Jun. 2023, the disclosure of which is incorporated herein by reference.

### BACKGROUND

### Field of the Invention

The invention relates to sliprings and parts thereof. Sliprings are used for transferring electrical signals and power between counter-rotating parts. A slipring may include a module having cylindrical conductive tracks rotating relative to brushes sliding on the tracks.

### Description of Related Art

A cast slipring module is disclosed in EP 1 320 155 A2. Conductive metal rings are cast into a plastic body which is held by cylindrical metal tube. The plastic body is difficult to adapt to different embodiment as changes in a mold are required. A more flexible approach is disclosed in US 2009/0091208 A1, where conductive rings are stacked with insulating support block sections on a hollow tube. US 2014/0120742 A1 discloses a rotary device with stackable slip ring elements, which are held together by a central rotor shaft (as shown in FIG. 3 of that publication).

### SUMMARY OF THE INVENTION

The embodiments of the invention provide a slipring module and components thereof which can be easily configured to different numbers and types of sliding tracks, which can be manufactured cost efficient, does not need a support shaft or tube and which can easily be assembled.

A deeper analysis of the slipring modules known from prior art has shown, that even modular solutions as disclosed in US 2009/0091208 A1 cannot easily be adapted to different configurations as at least the central hollow tube has to be adapted, e.g. cut to a specific length. Therefore, a configuration which does not depend on a fixed-length rigid tube is needed.

The embodiments discussed herein use a self-supporting structure which no longer requires or utilizes such a hollow tube.

In one embodiment, a support block includes electrically insulating material and is configured to hold at least one conductive sliding track. The given support block has a hollow disk-shaped body and connecting means, e.g., struts, for forming a fixed connection with at least a further (auxiliary) support block that has a structure substantially identical to that of the given support block, and thus for forming a self-supporting support structure, which is rigid and torsion resistant and that does not require and/or is necessarily devoid of yet another support structure utilized in relate art (such as, for example, a hollow shaft).

In another embodiment, a slipring module includes a plurality of support blocks stacked together, having fixed connections and holding at least one conductive sliding track. The support blocks may be identical, may have identical interfaces or may have at least matching interfaces. The slipring module is self-supporting and does not require a center axis or shaft. As a supporting shaft or tube is not needed, there is also no need to cut a supporting shaft or tube to a length given by the widths of the sliding tracks used, or to keep a large number of supporting shafts or tubes on stock. Further, the inner space blocked by a shaft or reduced by a tube may be used for wiring or other types of rotary joints, like optical joints, RF joints or media joints.

In a further embodiment, a slipring includes at least one slipring module and at least one brush interfacing with or sliding on at least one conductive sliding track.

A support block may include a dielectric or insulating material, e.g., a plastic material and has a hollow disk-shaped body. The body, which may be used for wiring, another slipring, or a central shaft. There is no need to connect a central shaft (if any is provided) to multiple support blocks as the support blocks form a self-supporting structure.

The body of the support block may provide insulation between neighboring sliding tracks. It may have a larger diameter than a sliding track providing an air gap and/or creepage distance together with a radial width and an axial width or thickness of the body. The axial width is defined in a direction parallel to a center axis of the body or of a slipring module which may be assembled from support blocks and tracks. The radial width is in a radial direction orthogonal to the center axis. For providing self-supporting properties with sufficient stability, there may be a minimum radial width and/or axial width of the body of the support block, which may be dependent of the outer diameter of the body. Typically, a radial width at about 10% (e.g. between 5% and 15%) or between 2% and 20% or 2% and 50% of the outer diameter has shown good results. In an example, a body of a support block with 70 mm diameter may have a radial width of 7 mm.

The minimum radial width may also be defined by the cross section of the wiring cables which are routed within the free inner diameter of the support blocks and tracks that are later assembled to a slipring module.

The axial width or thickness of the body of a support block may be defined by air gap and creepage requirements between neighboring tracks but also by mechanical stability and manufacturing requirements, with manufacturing methods e.g. being injection molding or 3D printing if made of plastic material or sinter or firing if made of ceramic material. Typically, an axial width at about 10% to 100% of the radial width has shown good results. In an example, a body of a support block may have a thickness in a range of 3 to 20 mm.

The body of a support block may hold means for cable management which may extend radially from the inner body and may include cable ties, strain reliefs or spokes for cable routing.

The body of a support block holds at least one means for interfacing e.g., interconnecting with another support block. Such means may be at least one connecting means, which may be a protrusion, and which may be extending from the body in a direction basically parallel to the center axis. In an embodiment, there are at least three connecting means that are substantially evenly spaced (azimuthally, as seen in a plane of the body of the support block). There may be also 4, 5, 6, 7, 8, 9 or any higher number of connecting means. The connecting means may be configured as a protrusion and/or have a cylindrical or cuboid or any other suitable shape and they may interface with openings or bores in a body of another support block, resulting in a first support block distance which may match to a first sliding track axial width.

In an embodiment, at least two different types of connecting means may be alternatingly or in groups arranged at a body of a support block. There may be 6 connecting means with 3 connecting means of a first type and 3 connecting means of a second type. The first type of connecting means may have a top protrusion at its end pointing away from the body, wherein the second type of connecting means may have a recess at its end pointing towards the body. The top protrusion is configured to fit into the recess, e.g., by a press-fit for interconnecting the bodies. This may result in a second support block distance which may be twice the first support block distance, and which may match to a second sliding track axial width. The top protrusion may be shaped as a dowel, the recess may be a cone shaped hole.

In at least one embodiment, at least one of the tabs, the protrusions, and the recesses of each type are substantially evenly spaced (at substantially equal angles from one another, as seen from the axis of the support block in a plane of the body of the support block, that is—azimuthally).

In another embodiment, the connecting means may include N types of connecting means, each type with M connecting means sequentially arranged. This may result N*M connecting means with N, M being integers that are equal to or greater than 1. An example with three types of connecting means (N=3) and four connecting means per type (M=4) may result in a sequence described as (NM) of: 11, 21, 31, 12, 22, 32, 13, 23, 33, 14, 24, 34. In a specific embodiment, the connecting means may in a N=2 and M=3 configuration include 6 connecting means with 3 connecting means of a first type and 3 connecting means of a second type, alternatingly arranged.

The connecting means may be positioned within a first radius matching with an inner radius of a sliding track, such that a sliding track may be seated on the connecting means. Further, the connecting means may have at least one ridge radially outside and parallel to the center axis. Such ridges provide a small and/or well-defined contact surface with the sliding tracks and may even be compressed slightly by the sliding tracks providing a higher friction and a stable seating of the sliding tracks.

The connecting means may be connected to a body of a support block by at least one bar or any other means which is configured to provide a minimum flexibility for displacement in a radial direction and/or tilt in an axial direction to compensate for tolerances.

Further, there may be at least one tab, on a side of the body of a support block opposing the connecting means mentioned above configured for providing connection between two support blocks. The tabs may be configured to interface with tab guides on the same side of the body, but on a different support block. There may be a press fit or a snap-in connection. This allows a back-to-back connection of two support blocks.

In an embodiment, there may be press fits or snap-ins between at least two or even between all support blocks which are strong enough to form a self-supporting structure. Alternatively, or in addition, the support blocks may be glued or welded together after the sliding tracks and/or insulating disks have been mounted.

The body of a support block may include further recesses and holes e.g. configured for wiring or for saving material and/or weight.

As a sliding track may be held at a side of a body of a support block, at least two support blocks connected together may be required to hold a sliding track in a stable position.

There may be at least one sliding track between two adjacent support blocks. There may also be arranged multiple sliding tracks spaced by insulating disks. In such an embodiment the sliding tracks and insulating disks may be configured to have a total width or thickness corresponding to the first support block distance or the second support block distance.

At least one sliding track includes conductive material, e.g., brass, gold, silver or a combination thereof, and has a ring shape. The ring shape may have an inner diameter matching to the support blocks, e.g., matching to the connecting means and an outer diameter which may be smaller (e.g. for a value in the range of 1 to 10 mm) than the outer diameter of an adjacent body of a support block. The at least one sliding track may have a means for electrical connection, e.g., wiring. Such a means may be a threaded hole, a screw or a solder or welding tab. Such a means may protrude from the inner diameter into the hollow space.

In an embodiment, a slipring module includes a plurality of the support blocks holding a plurality of sliding tracks. All support blocks of a module may be the same. The support blocks may provide at least one of the following types of connection:

Type 1 connection: A support block may be connected by its front side first connecting means and first top protrusions to another support block by its rear side. The first top protrusions interfacing with a first set of rear holes, a second set of rear holes or a third set of rear holes.

Type 2 connection: A support block may be connected by its front side first connecting means and first top protrusions to another support block by the support block's front side first connecting means and first top protrusions. Each support block's first top protrusions interfaces with a second set of front holes of the other support block. Creating an intertwined design.

Type 3 connection: Two support block may be connected by their front sides first connecting means and first top protrusions and front sides second connecting means having a hole or recess to adapt the first top protrusions. The first top protrusion of one support block interfaces with a second recess of the other support block. This connection results in a larger spacing between the support blocks, being about twice the distance of type 1 and type 2 connection.

Type 4 connection: Two support block may be connected by their rear sides. At least one rear tab of any support block interfaces with at least one tab guide of the other support block.

In an embodiment, at least one or a plurality of these connections may be used. Each support block may hold at least one sliding track or a plurality of sliding tracks separated by at least one insulation disk.

The support block may have further details e.g. a groove along the outer circumference of the body to increase the creepage distance. It may also have a recess at the axial end ends to form a pilot diameter for exact centering of the tracks. Further details of the support block might be means for cable management along the inner circumference of the body.

The support block may have holes and/or pockets which may be closed by a thin plastic film which is possible e.g. with injection molding. The film is broken only when the hole or pocket is used, thus preventing dust buildup in the hole or pocket when unused.

### BRIEF DESCRIPTION OF THE DRAWINGS

In the following, the invention will be described by way of example, without limitation of the general inventive concept, on examples of embodiment and with reference to the drawings.

FIG. 1 shows an embodiment of a slipring module.

FIG. 2 shows a side view of the embodiment of FIG. 1.

FIG. 3 shows a cut through the embodiment of the slipring module.

FIG. 4 shows a front view of a support block.

FIG. 5 shows a rear view of the support block.

FIG. 6 shows a top view of a front side of a support block.

FIG. 7 shows a bottom view of the rear side of the same support block.

FIG. 8 shows a side view of a support block.

FIG. 9 shows multiple support blocks combined into a stack.

FIG. 10 shows the stack of FIG. 9 in a side view.

FIG. 11 shows a complete slipring assembly in a sectional view.

FIG. 12 shows the complete slipring assembly in a different sectional view.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

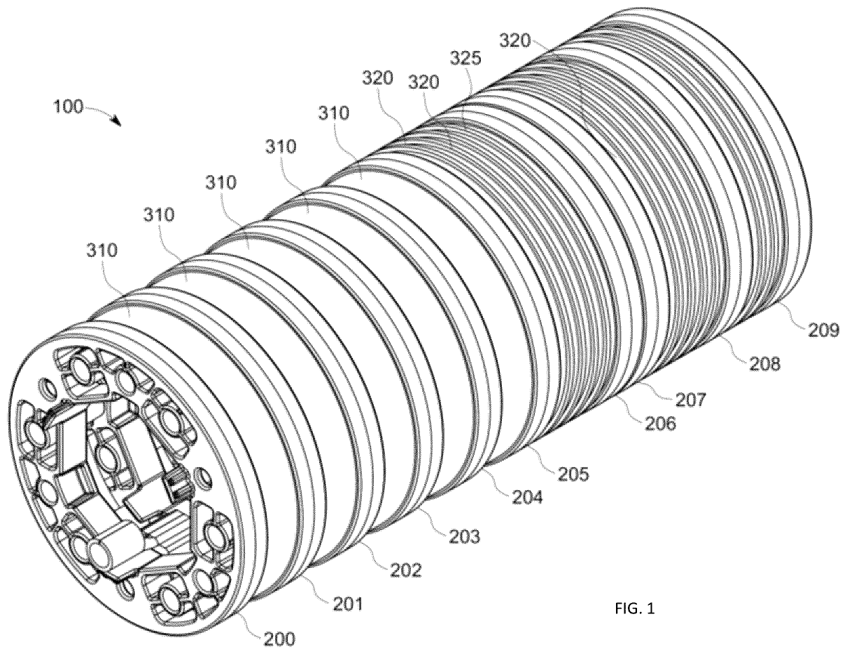

FIG. 1 shows an embodiment of a slipring module 100. The module includes a plurality of support blocks 200, 201, 202, 203, 204, 205, 206, 207, 208, 209. The support blocks may include a dielectric material, e.g., a plastic material. The support blocks may hold sliding tracks 310, 320. There may be different types of tracks, e.g., a first type of wider sliding tracks 310 and a second type of narrower sliding tracks 320. For example, between the support blocks 205 and 206, the distance is large enough to support five narrow second sliding tracks which are further separated by insulation disks 325. As will be shown later, the support blocks may be combined in different ways, such providing different distances between pairs of support blocks. These may be occupied by one or a plurality of sliding tracks. Each support block may be interconnected with neighboring support blocks to form a solid slipring module without requiring additional components for stabilizing and/or reinforcing the module.

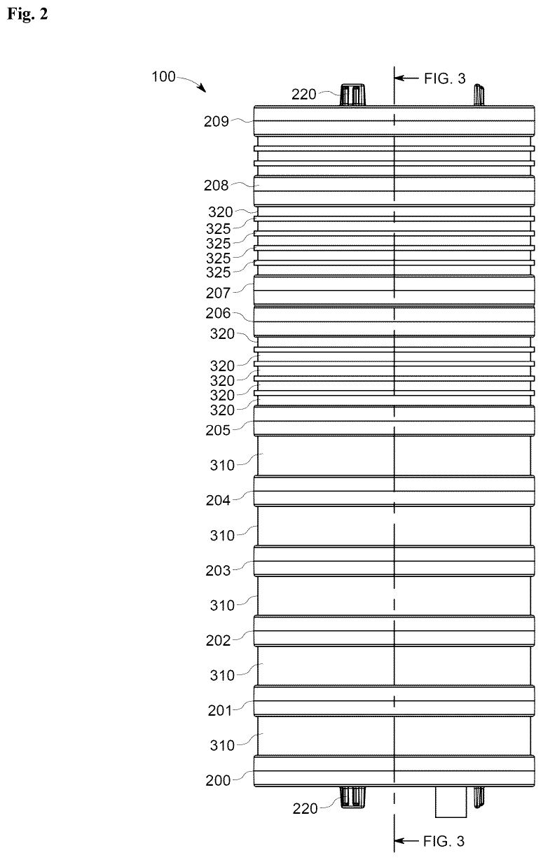

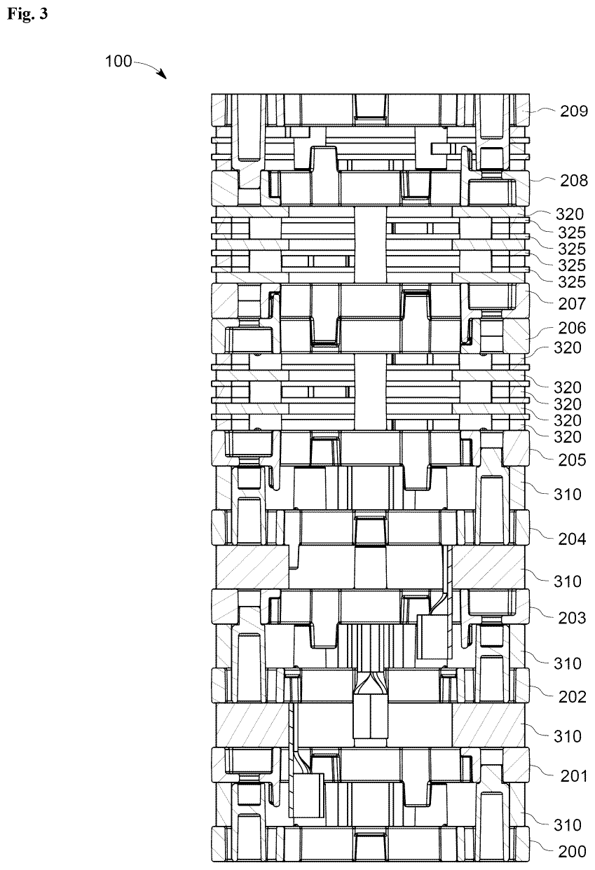

FIG. 2 shows a side view of the previous embodiment. Here again, the support blocks together with the sliding tracks can be seen. Further, first connecting means 220, which may be struts, are shown which may be used for interconnecting and/or centering support blocks. Further, a sectional cut shown in FIG. 3 is marked, passing through the center of the module.

FIG. 3 shows a cut through the module of a previous embodiment. It shows a comparatively complex internal structure which will be explained later in detail. What can be seen is the simple structure of the first sliding tracks 310 and the second sliding tracks 320. The sliding tracks may only be a hollow cylindrical part of a conductive material, e.g., copper, brass or steel or any other conductive material. The sliding tracks may be cut from a casted, drawn or extruded semi-finished tube or casted, forged, extruded or printed as single part. Further, the insulation disks 325 may also have a very simple structure in the form of a hollow cylinder. They may have the same inner diameter and a slightly larger outer diameter than the sliding tracks, which helps to increase insulation e.g., by increasing the creepage, they may have a pilot diameter (a radial step in axial thickness) to precisely center to the neighboring tracks.

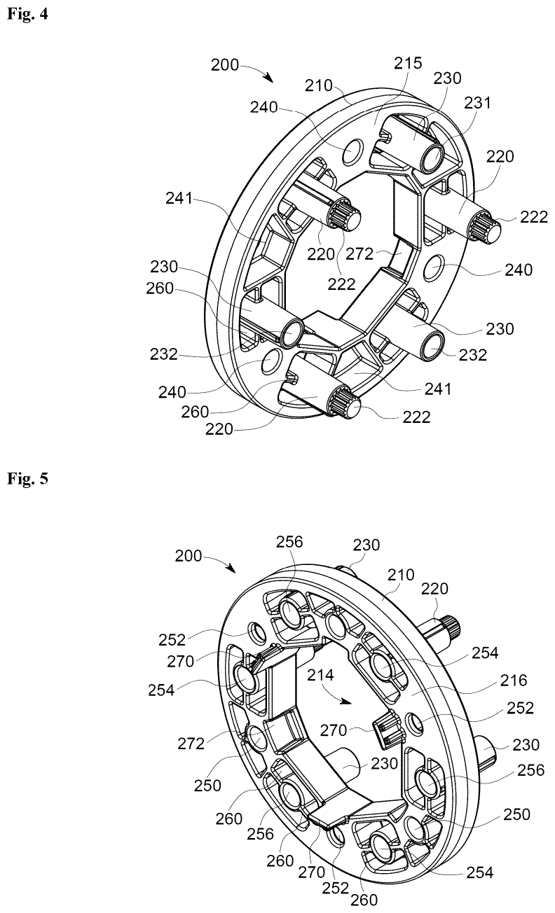

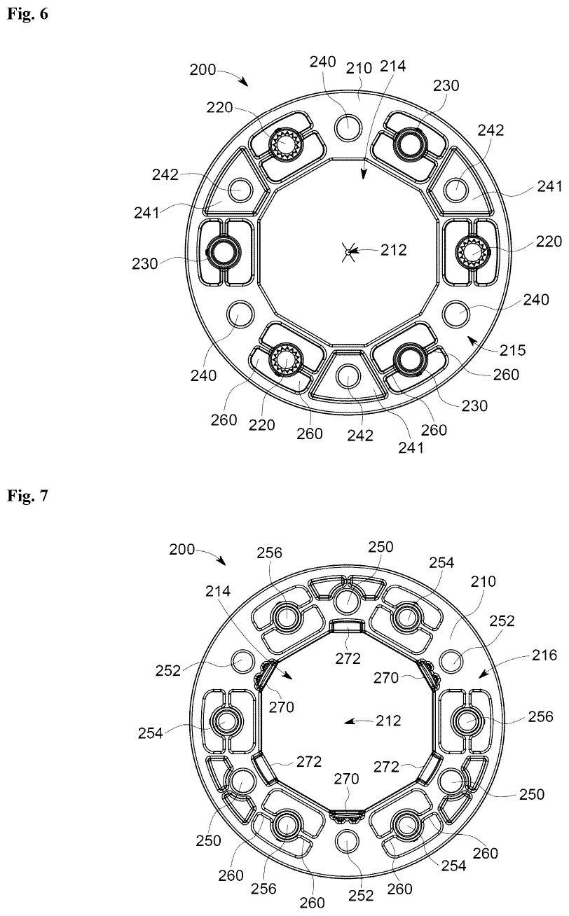

FIG. 4 shows a front view of a support block 200, while FIG. 5 shows a rear view of the same support block 200. Basically, the support block includes a generally disk-shaped body 210 having a central opening or hollow therethrough (overall resembling a hollow cylinder having a substantially annular cross section in a plane transverse to the axis of the body). The body further possesses multiple cut-outs and/or protrusions. (Notably, the central hollow in the body 210 may have a substantially polygonal perimeter, as clearly illustrated in FIG. 6.) The disk-shaped body 210 may include a first surface on the front side 215 opposing a second surface (rear side).

From the second surface, there may be at least one recess or hole. There may be a first set of rear holes having a first diameter. These holes may be through-holes and may exit the body at holes 240. These holes may have diameters substantially matching the dimensioned of first top protrusions 222 of first connecting means 220 (that protrude from the first surface 215). Such dimensional coordination may allow to provide a comparatively robust connection between at least two support blocks, e.g. via a press fit or snap-in connection. The top protrusion may be shaped as a dowel, the hole may be cone shaped. As shown in the present non-limiting example, each support block has three first top protrusions 222 and three holes 250/240. Based on this, multiple support blocks may be stacked on top one another while oriented in the same direction, such that a first top protrusion 222 is placed into a first rear hole 250. With three top protrusions 222 present in each of the blocks, the resulting stack is a mechanically stable system. Further, two support blocks may be stacked on top of each other while being oriented in opposite directions, which means that first top protrusions 222 of a first support block are plugged into a first set of front holes 240 of a second support block which at the same time may result in the first top protrusions 222 of a second support block are plugged into the first set of front holes of the first support block. As a skilled person will readily appreciate, such arrangement results in an even more solid connection based on the three first connecting means 220.

A third way of connecting two support blocks is by plugging the first top protrusions 222 of a first support block into second recesses 231, 232 being part of second connecting means 230 of a second support block. With three pairs of support blocks alternatingly arranged as shown in FIGS. 4 and 5, this may result in six connections by first and second connecting means between the support blocks.

Further, in FIG. 5, tabs 270 are shown. These tabs of a given support block may be plugged into tab guides 272 of another support block such that the support blocks are interconnected by their second surfaces (rear sides). If two symmetric support blocks are interconnected, there are six tabs shown in this example which ensure a rigid coupling of the support blocks.

Further optional pockets 241, formed in a body of the block 200, are shown in FIG. 4. Formation of such pockets may save material and thus reduce weight of the block when the support block is injection molded and/or save production time when the block is printed. The pocket may have a hole to mount the support block to a bearing flange (discussed below). The support block may be manufactured from a plastic material., e.g., a thermoplastic or duroplastic material e.g. Polyamide, Polyurethane, Polycarbonate, Epoxide, Polyethylene, Polyoxymethylene, Polyetherethercetone or Polyphenylene Sulfide, it may be fiber or particle enforced incorporating e.g. glass fibers, Kevlar fibers or carbon fibers. The plastic material may have additives to ensure low flammability.

Alternatively, the support block may be manufactured of ceramic material, e.g. steatite, alkali aluminum silicates, magnesium silicates, titanates, alkaline earth metal aluminum silicates, aluminum and magnesium silicates, mullite and aluminum oxide.

FIGS. 6 shows a top view from the first surface or front side of a support block 200, while FIG. 7 shows a bottom view from the second surface (rear side) of the same support block. There are further holes 242 as a second set of front holes from the first surface 215 (front side) extending in second set of rear holes 252 on the second surface (rear side). These holes may be used, e.g., for screws or other attachment means for coupling or attaching a support block to an adapter, holding the slipring module. As the second set of front holes 242 may be in recesses, there is enough space for a screwhead.

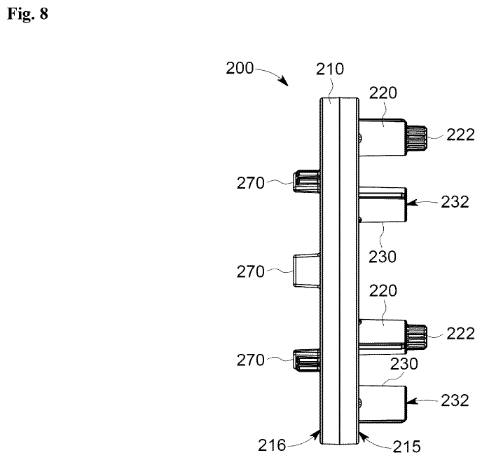

FIG. 8 shows a side view of a single support block. The second connecting means 230 may have the same length as the first connecting means 220 to provide further stability.

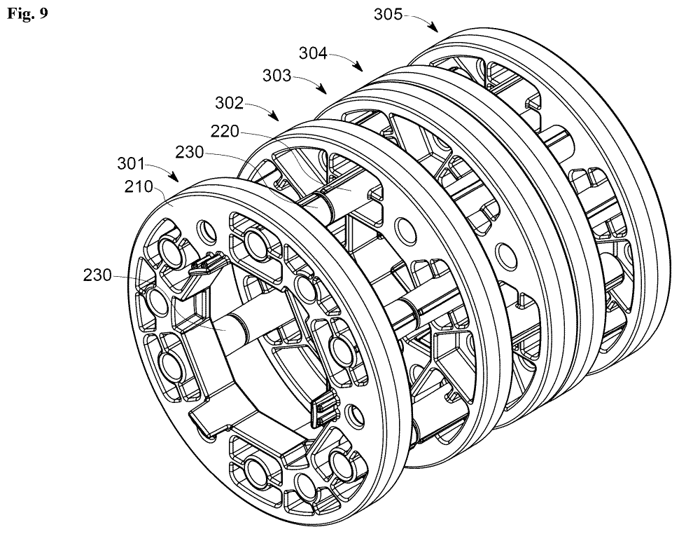

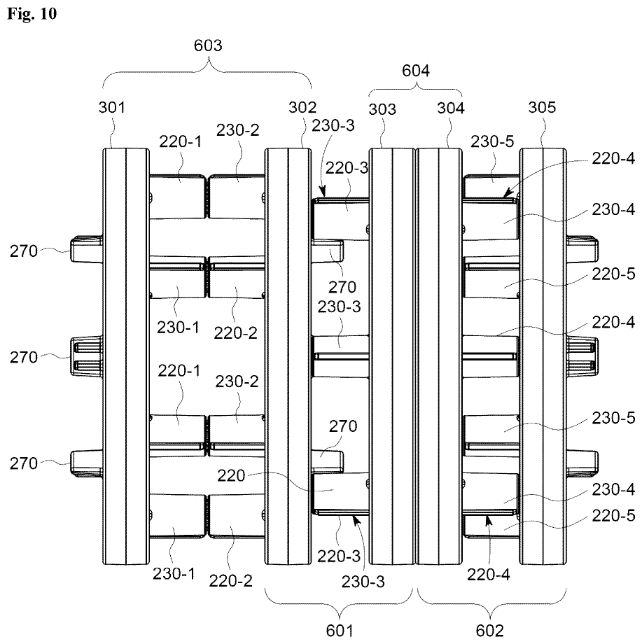

FIGS. 9 and 10 show different types of connections between multiple support blocks 301, 302, 303, 304, and 305 that form the stack. (Here, FIG. 10 is a side view of that shown in FIG. 9.) When multiple blocks are assembled in a stack for formation of a slipring module, the gaps left between the support blocks may be optionally filled with sliding tracks or sliding track combinations of different kinds. (The depiction of such filling elements is left out in FIGS. 9 and 10, for simplicity of illustration.) Here, the reference signs are extended by a digit indicating the support block to which the part belongs. The connection types are:

Type 1 connection 601, illustrated between the second support block 302 and the third support block 303. The third support block 303 may be connected with the first connecting means 220-3 and first top protrusions 222 present on the front side of the block 302 to the rear side of the second support block 302. The first top protrusions 222 may be interfacing with a first set of rear holes, a second set of rear holes or a third set of rear holes in the second support block 302. The second connecting means 220-3 give additional stability although they are only in surface contact with the second support block 302. This embodiment has three first connecting means 220-3, resulting in three fixed connections between first top protrusions 222 and rear holes 250.

Type 2 connection 602 is illustrated between the fourth support block 304 and the fifth support block 305. The fourth support block 304 may be connected by the first connecting means 220-4 and first top protrusions 222 located at the front side of the block 304 to the first connecting means 220-5 and first top protrusions 222 at the front side of the block 305. Each support block's first top protrusions 222 interfaces with a corresponding second set of front holes 242 of the other support block. The second connecting means 220-4 and 220-5 provide additional stability although they are only in surface contact with each opposing support block 305 and 304. This embodiment has three first connecting means 220-4 and three first connecting means 220-5, resulting in a more stable connection than type 1 may provide.

Type 3 connection 603 is shown between the first support block 301 and the second support block 302. The first support block 301 may be connected by the first connecting means 220-1 on its front side to the second connecting means 230-2 on the front side of the second block 302, such that first top protrusions 222 of the first connecting means interface with second recesses 232 of second connecting means 230. Such structural cooperation may result in a larger spacing between the interfacing support blocks, being twice the axial width (as compared with the interblock-spacings corresponding to type 1 and 2 connections) if the first and second connection means are of same length as shown in the non-limiting example of FIGS. 9, 10, and allows to hold wider sliding tracks or a higher number of smaller sliding tracks which may be separated by insulating disks. This embodiment has three first connecting means 220-1 and three first connecting means 220-2, resulting in a more stable connection than type 1 may provide.

Type 4 connection 604 is illustrated between the third support block 303 and the fourth support block 304. These two support blocks may be connected at their rear sides, for example with rear tabs 270 of the third support block 303 interfacing with tab guides 272 of the fourth block 304 while rear tabs 270 of the fourth support block 304 interface with tab guides 272 of the third block 303. Such structural cooperation allows for a close back-to-back connection between the two interfacing support blocks.

Generally, at least one or a plurality of these connections may be used in any sequence. Further, there may be any number of connecting means.

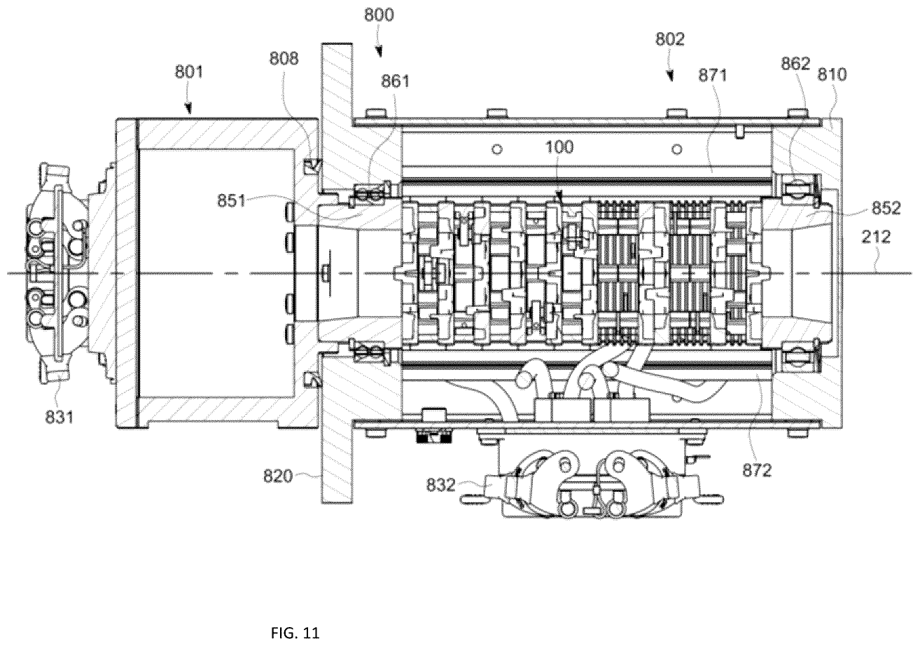

FIG. 11 shows a complete embodiment of a slipring 800 in a sectional view. The slipring 800 has a rotating part 801 and a stationary part 802. (Understandably, the roles of rotating and stationary parts may also be exchanged.) The slipring may be mounted by a mounting flange 820 and electrically connected by rotating connector 831 and stationary connector 832. A first bearing flange 851 holds a first bearing 861. A second bearing flange 852 holds a second bearing 862. Aluminum rods or profiles 871, 872 may be provided for holding brush blocks and/or brushes.

At least one of the bearing flanges may be mounted to the adjacent support block by using glue or by screws employing the existing holes, e.g. holes 242, 252, or recesses when formed as a hole. All or some of the support blocks may be glued but the preferred connection between the support blocks is press fit or snap-in connection. This allows easy disassembly during repair and separation of materials at end of life.

The axial module may be braced between the bearing flanges with a plate spring or wave spring, with the distance being defined by the housing or the aluminum rods.

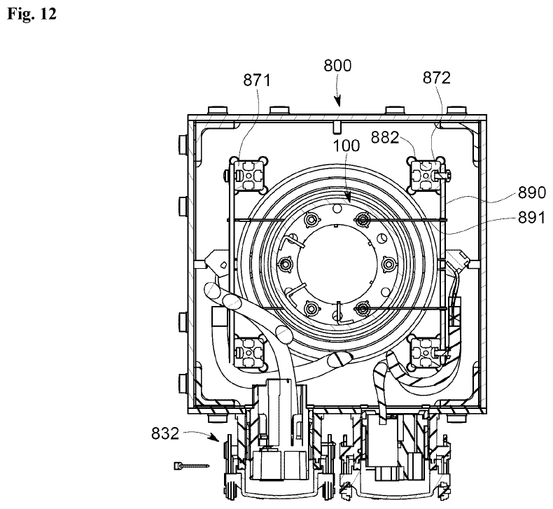

FIG. 12 shows an example of the complete slipring assembly in a different sectional view. Here, a printed circuit board 890 forming a brush block together with brushes 891 are shown. In this drawing the brushes are shown simplified: brushes 891 are shown in a position when the module is not mounted. A brush may be made of a single wire, multiple parallel wires e.g. bristle brush or a metal graphite type (not shown here). The brush block 890 may be mounted and axially adjusted by screws using a nut stone in a slot 882 of the profiles 871 as abutment.

The sliding tracks are generally ring shaped and may have eyelets or lugs for contacting or threaded holes or terminal wire soldered or welded to the ring as terminal to connect the wiring, the terminals may be placed at certain angles to ease the assembly and wiring.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value.

The term “A and/or B” or a similar term is defined to be interchangeable with the term “at least one of A and B.”

It will be appreciated to those skilled in the art having the benefit of this disclosure that this invention is believed to provide a support block for sliprings. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 slipring module
200-209 support block
210 disk-shaped body
212 center axis
214 center opening or bore
215 first surface (front side)
216 second surface (rear side)
220 first connecting means
222 first top protrusion
230 second connecting means
231,232 second recess
240 first set of front holes (front recess)
241 pockets
242 second set of front holes (recessed)
250 first set of rear holes which may be throughholes with 240
252 second set of rear holes
254 third set of rear holes protruding into 220
256 fourth set of rear holes protruding into 230
260 support connecting means
270 rear tabs
272 tab guide
301 first support block
302 second support block
303 third support block
304 fourth support block
305 fifth support block
310 first sliding track (wide)
320 second sliding track (narrow)
325 insulation disk
601 type 1 connection
602 type 2 connection
603 type 3 connection
604 type 4 connection
800 slipring
801 rotating part
802 stationary part
820 mounting flange
831 rotating connector
832 stationary connector
851 first bearing flange
852 second bearing flange
861 first bearing
862 second bearing
871, 872 aluminum profile
882 profile slot
890 printed circuit board
891 slipring brush
10 gantry

1. A support block for forming a self-supporting modular slipring module that comprises an electrically insulating material and that is configured to hold at least one sliding track, the support block including:
a substantially disk-shaped body having a center opening or bore at a center axis thereof, and
at least one connecting means at the body, said at least one connecting means configured to form a fixed connection with at least an auxiliary support block to form a self-supporting rigid and torsion-resistant structure.

2. A support block according to claim 1, wherein the at least one connecting means is dimensioned as a protrusion extending from the body in a direction parallel to the center axis.

3. A support block according to claim 2, wherein the body includes at least three top protrusions that are substantially evenly angularly spaced from one another, and
the top protrusions interface with openings or bores in a body of the auxiliary support block.

4. A support block according to claim 2, wherein the at least one connecting means include multiple connecting means, the multiple connecting means representing N different types of connecting means, each of the N different types including M connecting means, the connecting means of N different types being sequentially arranged, wherein N and M are integer numbers.

5. A support block according to claim 2, wherein the multiple connecting means include 6 connecting means with 3 connecting means of a first type and 3 connecting means of a second type, alternatingly arranged.

6. A support block according to claim 4, wherein a connecting means of the first type has a further top protrusion at an end thereod and pointing away from the body,
a connecting means of the second type has a recess at an end thereof formed in a direction towards the body, and
wherein the further top protrusion is dimensioned to fit into the recess.

7. A support block according to claim 4, wherein a connecting means of a first type of the N types and a connecting means of a second type of the N types are dimensioned to form a press fit or a snap-in connection with one another.

8. A support block according to claim 2, wherein the at least one connecting means is positioned within a first radius that dimensionally matches with an inner radius of the at least one sliding track.

9. A support block according to claim 2, configured to support the sliding track seated on the at least one connecting means.

10. A support block according to claim 2, wherein the at least one connecting means has at least one ridge radially outside and parallel to the center axis and configured to provide a contact surface with the sliding tracks.

11. A support block according to claim 2, wherein the at least one connecting means is connected to a body by at least one bar or by an alternative means that is configured to provide flexibility for displacement in a radial direction and/or tilt in an axial direction to compensate for tolerances.

12. A support block according to claim 2, wherein at least one tab is provided on a side of the body opposing the at least one connecting means, the at least one tab being configured to connect the support block with the auxiliary support blocks.

13. A support block according to claim 12, wherein the at least one tab of the is configured to interface with a pocket formed on a corresponding side of a body of the auxiliary support block.

14. A support block according to claim 13, wherein the at least one tab, the connecting means, and the recesses of each type are evenly spaced.

15. A support block according to claim 14, wherein the body has a radial width larger than 5%, 10%, 15% or 20% of an outer diameter of the body.

16. A slipring module comprising a plurality of the support blocks according to claim 1, wherein the support blocks of the plurality of the support blocks are stacked together, have fixed connections with immediately adjacent support blocks, and holding at least one conductive sliding track.

17. A slipring comprising at least one slipring module according to claim 16, wherein the slipring further includes at least one brush interfacing with or sliding on the at least one conductive sliding track.
